(19) United States
(12) Patent Application Publication
(10) Pub. No.: US 2009/0282826 A1
(43) Pub. Date: Nov. 19, 2009

(54) THERMODYNAMIC MACHINE WITH CONTINUOUSLY CIRCULATING REFRIGERANT

(76) Inventor: Gerard Murat, Saillans (FR)

Correspondence Address: DENNISON, SCHULTZ & MACDONALD, 1727 KING STREET, SUITE 105, ALEXANDRIA, VA, 22314, US

(21) Appl. No.: 11/720,940

(22) PCT Filed: Dec. 13, 2005
(86) PCT No.: PCT/FR2005/003111

§ 371 Date: Jul. 11, 2007

(30) Foreign Application Priority Data
Dec. 13, 2004 (FR) 0413206

(51) Int. Cl. F02G 1/043

(52) U.S. Cl. 60/516

(57) ABSTRACT

A thermodynamic machine including a closed circuit for the circulation of a refrigerant fluid, a heat exchanger, a cold inlet, and at the exchanger output, a hot outlet, at least one first variable-volume enclosure acting on a mobile member communicating its movement to an output system, and a cooler. According to the invention, the machine further includes at least one variable-volume enclosure controlled by the output system by being interposed between the cold inlet of the circuit and the cooler outlet, with such a chamber providing, for an operating cycle of the enclosure, reinjection of liquid into the exchanger to maintain the pressure at the hot outlet of the circuit at a substantially constant value.

This present invention concerns a thermodynamic machine employing a refrigerant fluid and operating according to the Carnot principle.

The subject of the invention concerns a thermodynamic machine operating as a motor or a pump used to convert heat energy into mechanical energy.

From state of the art, we are already familiar with various types of thermodynamic machine. For example, document WO 03/031 776 describes a thermodynamic machine that includes a heat exchanger with part of a circuit for the circulation of a refrigerant fluid. The machine also includes two variable-volume enclosures operating in opposition and connected to the hot outlet of the exchanger. The outlets of the enclosures are connected, via a cooler and a pump, to the cold inlet of the heat exchanger. A drawback of such a machine concerns the requirement to provide a pump for the circulation of the refrigerant fluid, which reduces the efficiency of such a thermodynamic machine.

The purpose of the invention is to propose a thermodynamic machine that is designed to operate independently from a source of heat, raising the temperature of a refrigerant fluid.

Another objective of the invention is to propose a thermodynamic machine that has an efficiency that is better than that of the known thermodynamic machines.

In order to attain such an objective, the thermodynamic machine of the invention includes:
a closed circuit for the circulation of a refrigerant fluid,
a heat exchanger with a part for circulation of the refrigerant fluid, having a cold inlet at the inlet of the exchanger and a hot outlet at the outlet of the exchanger,
at least one first variable-volume enclosure whose inlet is connected to the hot outlet of the circuit and whose outlet is connected to the inlet of a cooler, with the enclosure acting on a mobile device that is communicating its movement to an output system,
and a cooler, placed between the outlet of the enclosure and the cold inlet of the circuit.

According to the invention, the machine includes at least one variable-volume enclosure that is controlled by the output system by being placed between the cold inlet of the circuit and the outlet of the cooler, where such a chamber, for one cycle of operation of the enclosure, performs the re-injection of the liquid into the exchanger in order to maintain the pressure at the hot outlet of the circuit at a value that is substantially constant.

According to a preferred implementation variant, the thermodynamic machine includes a second variable-volume enclosure** whose inlet is connected to the hot outlet of the circuit and whose outlet is connected to the inlet of the cooler, with this second enclosure acting on a mobile device which is arranged, in opposition in relation to the mobile device of the first enclosure, to communicate its movement to the output system.

According to an advantageous implementation variant, the variable-volume enclosure has a variable volume that is less than the volume of the first and/or the second enclosure, in a ratio that depends on the characteristics of the fluid used so as to have equality between the mass of the gas moved and the mass of the liquid moved.

Preferably, the variable-volume enclosure is controlled by a piston which is operated by the output system and with a section designed to re-inject the liquid into the heat exchanger.

Advantageously, the thermodynamic machine includes controlled closure devices associated with the inlets-outlets of the enclosures and of the chamber. For example, the closure devices are controlled by means which are driven by the movement of the output system.

According to one implementation example, the output system includes an output shaft fitted with a crankshaft to which are connected the mobile devices of the enclosures, the output shaft being equipped with cams that are used to control the closure devices. Preferably, the output shaft acts upon the piston of the variable-volume enclosure by means of a speed-multiplier system.

Advantageously, the cold inlet and the hot outlet of the circulation circuit are equipped with controlled closure devices whose operation is synchronised with the operation of the controlled closure devices associated with the enclosures and the chamber.

Various other characteristics will emerge from the description that follows, with reference to the appended drawings which show, by way of non-limiting examples, different forms of implementation of the subject of the invention.

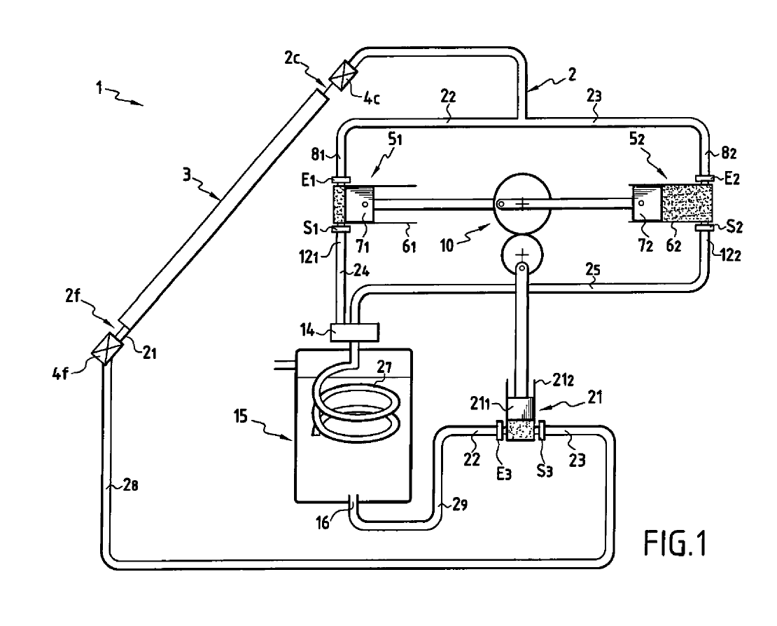

FIG. 1 is a schematic view of one implementation example of a thermodynamic machine according to the invention.

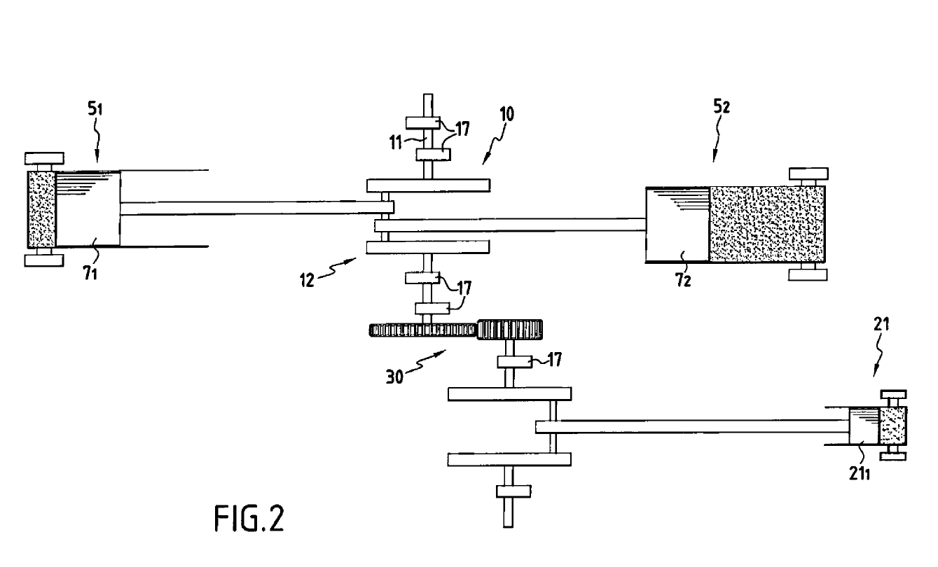

FIG. 2 is a schematic view of the principle of an output system of a thermodynamic machine illustrated to FIG. 1.

FIGS. 1 and 2 illustrate one implementation example of a thermodynamic machine 1 according to the invention, that includes a closed circuit 2 for the circulation of a refrigerant fluid such as the R 407 refrigerant gas for example. The thermodynamic machine 1 includes a source of heat such as a heat exchanger 3 with a part 2₁ of the circulation circuit for the refrigerant fluid 2.

The heat exchanger 3 can be used to raise the temperature of the refrigerant fluid to a level, for example, of between 60° C. and 100° C., designed to increase the pressure of the refrigerant fluid so that it reaches 40 to 50 bars when it is contained in a sealed enclosure. As an example, the heat exchanger 3 can be of the solar type, the industrial water-cooler type, the smoke-conduit type, etc.

The circulation circuit 2 includes a cold inlet 2f at the inlet of the exchanger 3, and a hot outlet 2c at the outlet of the exchanger. The cold inlet 2f and the hot outlet 2c are respectively equipped with controlled valves 4f, 4c.

The thermodynamic machine 1 also includes at least one first, and in the example a first 5₁ and a second 5₂, variable-volume enclosure. Each variable-volume enclosure 5₁, 5₂ has a volume that is closed by at least one deformable wall that is used to vary the pressure and the volume inside the sealed enclosure. Such a variable-volume enclosure 5₁, 5₂, or internal combustion chamber, can be implemented in any appropriate manner such as by membrane, turbine or piston. In the example illustrated in the figures, each enclosure 5₁, 5₂ is composed of a cylinder 6₁, 6₂ that is closed off by a piston 7₁ and 7₂ respectively. Each enclosure 5₁, 5₂ is intended to be fed with refrigerant fluid via an inlet 8₁, 8₂ respectively connected to the hot outlet 2c by means of a part 2₂ and 2₃ respectively of circuit 2.

Each piston 7₁, 7₂ communicates its movement to an output system 10 of any type whose movement energy can be used directly, or converted for various applications. In the example illustrated particularly in FIG. 2, the output system 10 includes a rotating output shaft 11 fitted with a crankshaft 12 onto which are fixed the rods of the pistons 7₁, 7₂. Advantageously, the rods of the pistons 7₁, 7₂ are mounted on the same axis so as to function in opposition, so that when one enclosure has a minimum volume, the other enclosure has a maximum volume.

Each enclosure 5₁, 5₂ has an outlet 12₁, 12₂ respectively for the refrigerant fluid, connected by a part 2₄, 2₅ to the inlet 14 of a cooler 15. The circulation circuit 2 thus includes a part 2₇ that extends in relation to the cooler 15. Advantageously, the cooler 15 can be used to return the refrigerant fluid from the gaseous state to the liquid state so that, within the cooler 15, there is established a liquid zone with a gaseous zone above it. The cooler 15 includes an outlet 16 located at the level of the liquid zone and connected to the cold inlet 2f of the heat exchanger 3 by means of a part 2₈ of circuit 2.

It should be noted that the inlets and the outlets of the enclosures 5₁ and 5₂ are equipped with controlled closure devices E₁, E₂, S₁, S₂ respectively of any type already known in themselves, such as valves or distributors. These controlled closure devices E₁, E₂, S₁, S₂ are advantageously controlled by means 17 that in turn are driven by the movement of the output system 10. To this end, the output shaft 11 is equipped with cams used to act directly or indirectly on the closure devices, in accordance with an operating cycle which will be describes more precisely in the remainder of the description. It should be noted that these means 17 controlled by the output system 10 can also be used to control the controlled closure devices 4f, 4c. However, these controlled closure devices 4f, 4c can also be controlled by the pressure of refrigerant fluid. In this case, the closure devices 4f, 4c are non-return valves.

The cooler 15, which constitutes the cold source of the thermodynamic machine 1 is of any type already known in its own right, used to lower the temperature of the refrigerant fluid and thus to lower its pressure. It should be noted that the expansion of the refrigerant fluid necessarily results in the absorption of calories producing cold which can advantageously be recovered by the cooler.

The thermodynamic machine 1 also includes at least one variable-volume enclosure 21 controlled by the output system 10, this being placed between the cold inlet 2f of the circuit and the outlet 16 of the cooler 15. In the example illustrated, the variable-volume enclosure 21 is composed of a piston 21₁, and a cylinder 21₂ which is equipped firstly with an inlet 22 connected by a part 2₉ of circuit 2 to the outlet 16 of the cooler, and secondly of an outlet 23 connected to the cold inlet 2f of the circuit by part 2₈ of the circuit. The inlet 22 and the outlet 23 of the chamber 21 are equipped with closure devices E₃ and S₃ respectively which are also controlled by the output system 10, by cams 17 for instance.

In an advantageous manner, the variable-volume enclosure 21 has a variable volume that is less than the volume of the first and/or the second enclosure, in a ratio that is established as a function of the characteristics of the fluid used, and so as to have equality between the mass of the gas moved, that is entering into the cooler 15, and the mass of the liquid moved on the piston. The piston 21, associated with this chamber has a section that is as small as possible, in order that the force necessary for the injection of the liquid into part 2₈ of the circuit should be as low as possible, in order to retain the maximum of energy at the output shaft 11.

The piston 21₁, is driven by the output system 10, so as to perform, for one cycle of operation of a enclosure 5₁, 5₂, the re-injection of the coolant liquid into the heat exchanger 3 in order to maintain the pressure at the hot outlet 2c of the circuit at a value that is substantially constant. The piston 21₁ thus allows the coolant liquid to be re-injected into the heat exchanger 3 in small quantities.

Advantageously, the piston 21, is connected to the output shaft 11 by means of a speed-multiplier system 30. For example, the piston of the chamber 21 executes one full cycle while the piston of a chamber 5₁, 5₂ executes an excursion in one determined direction. The operation of the thermodynamic machine directly follows the above description.

During a heating phase of the refrigerant fluid, the coolant fluid in part 2₁ of the circuit undergoes a temperature rise, its pressure increases, and it can change state. It should be noted that the closure devices E₁, S₂, E₃, S₃ are considered to be open while the closure devices E₁, E₂ and S₁ are closed.

When the refrigerant fluid reaches a given value of pressure, of between 30 and 50 bars for example, the refrigerant fluid enters into the first enclosure 5₁, exerts a pushing force on piston 7₁, and moves the output shaft 11 of the output system. Simultaneously, piston 7₂ chases the fluid contained in enclosure 5₂ in the direction of the cooler 15.

At the end of the go trajectory of piston 7₁, and therefore the return trajectory of piston 7₂, closure devices E₁ and S₂ are closed while closure devices E₂ and S₁ are open, allowing continuation of the cycle as described above, with reversal of the functions or roles between enclosures 5₁ and 5₂.

It should be noted that during the go trajectory of piston 7₁, the variable-volume enclosure 21 completes a full go and return cycle, allowing part of the fluid to be returned to the exchanger 3. The variable-volume enclosure 21 thus allows the pressure of the refrigerant fluid to fall in the hot part of the circuit, allowing injection of the coolant liquid at a lower temperature into the heat exchanger 3. It then follows that the refrigerant fluid, having filled the heat exchanger 3, experiences a rise in both its temperature and pressure. To the extent that the pressure at the hot outlet 2 is less than the pressure of the refrigerant fluid in the exchanger 3, refrigerant fluid can be injected into the hot outlet 2 from the exchanger 3. In addition, it should be understood that the variable-volume enclosure 21 injects the coolant liquid into the exchanger 3 in such a manner that the pressure at the hot outlet 2 returns to its nominal value, meaning that is it held at a value that is substantially constant. A fresh thermodynamic cycle as described above then begins again, independently or automatically.

The invention is not limited to the examples described and illustrated above, since various modifications can be made to it without going outside of its scope as claimed.

1. A thermodynamic machine, that includes
a closed circuit (2) for the circulation of a refrigerant fluid,
a heat exchanger (3) with a part (2₁) of the circulation circuit of the refrigerant fluid having a cold inlet (2f) at the inlet of the exchanger, and a hot outlet (2c) at the outlet of the exchanger,
at least one first variable-volume enclosure (5₁) whose inlet is connected to the hot outlet of the circuit and whose outlet is connected to the inlet of a cooler (15), with the enclosure acting on a mobile device that is communicating its movement to an output system (10),
and a cooler (15), placed between the outlet of the enclosure and the cold inlet (2f) of the circuit,
characterised in that the machine includes at least one variable-volume enclosure (21) controlled by the output system (10) by being placed between the cold inlet (2f) of the circuit and the outlet of the cooler, with such a chamber (21) performing, for one cycle of operation of the enclosure, the re-injection of the liquid into the exchanger in order to maintain the pressure at the hot outlet (2c) of the circuit at a value that is substantially constant.

2. A thermodynamic machine according to claim 1, characterised in that it includes a second variable-volume enclosure (5₂) whose inlet is connected to the hot outlet (2c) of the circuit, and whose outlet is connected to the inlet of the cooler (15), with this second enclosure (5₂) acting on a mobile device which is arranged, in opposition in relation to the mobile device of the first enclosure, to communicate its movement to the output system (10).

3. A thermodynamic machine according to claim 1, characterised in that the variable-volume enclosure (21) has a variable volume that is less than the volume of the first and/or the second enclosure, in a ratio that depends on the characteristics of the fluid used, so as to have equality between the mass of gas moved and the mass of liquid moved.

4. A thermodynamic machine according to claim 1, characterised in that the variable-volume enclosure (21) is controlled by a piston (21₁) operated by the output system (10) and with a section that is designed to re-inject the liquid into the heat exchanger (3).

5. A thermodynamic machine according to claim 1, characterised in that it includes controlled closure devices (E₁, S₁; E₂, S₂; E₃, S₃) associated with the inlets-outlets of enclosures 5₁ and 5₂ and of chamber 21.

6. A thermodynamic machine according to claim 5, characterised in that the closure devices (E₁, S₁; E₂, S₂; E₃, S₃) are controlled by means (17) that in turn are driven by the movement of the output system (10).

7. A thermodynamic machine according to claim 6, characterised in that the output system (10) includes an output shaft (11) fitted with a crankshaft (12) to which are connected the mobile devices of the enclosures, with the output shaft (11) being equipped with cams (17) that are used to control the closure devices.

8. A thermodynamic machine according to claim 5, characterised in that the output shaft (11) acts upon the piston (21₁) of the variable-volume enclosure (21) by means of a speed-multiplier system (30).

9. A thermodynamic machine according to claim 1, characterised in that the cold inlet (2f) and the hot outlet (2c) of the circulation circuit are equipped with controlled closure devices (4c, 4f) whose operation is synchronised with the operation of the controlled closure devices associated with enclosures 5₁ and 5₂ and chamber 21.
